(19) United States
(12) Patent Application Publication
(10) Pub. No.: US 2010/0098523 A1
(43) Pub. Date: Apr. 22, 2010

(54) Device For Conveying And Removing Glass Waste In A Machine For Filling Vials

(75) Inventor: Dario ANATRINI, Siena (IT)

Correspondence Address: WILLIAM J. SAPONE;COLEMAN SUDOL SAPONE P.C., 714 COLORADO AVENUE, BRIDGE PORT, CT, 06605, US

(73) Assignee: CO.RI.M.A. S.R.L., Monteriggioni (Siena) (IT)

(21) Appl. No.: 12/571,544

(22) Filed: Oct. 1, 2009

(30) Foreign Application Priority Data
Oct. 17, 2008 (IT) BO2008A 000643

(51) Int. Cl. B65G 1/133

(52) U.S. Cl. 414/751.1

(57) ABSTRACT

Device for conveying and removing glass waste, of the type which is associable to a sealing station of glass vials in a machine for filling the vials, operating in a chamber in which there is a controlled atmosphere. The glass waste are unloaded by gripping means, provided in the sealing station, in a hopper located laterally of said sealing station and conveyed, by means of conveyor organs, to a collection container of such waste, which is positioned in a different environment from the controlled-atmosphere one.

### BACKGROUND OF THE INVENTION

The present invention relates to a device for conveying and removing glass waste, of the type which is associable to a sealing station of glass vials in a machine for filling vials.

Machines for filling glass vials with various liquid substances, which for working needs operate in sterile chambers in which there is a controlled atmosphere (i.e. with a number of polluting particles, microbes and other inorganic portions present in the air volumetric unit, which is lower than a determined value) have been known so far.

These glass vials (1), shown in FIG. 1, are made up of a body (3), intended to be filled up to a predetermined level, and of a neck (2) which is open on the upper portion, the so-called “mouth” (8).

They are previously sterilized according to known techniques and fed to the filling machine.

The filling of the vials (1) is carried out in a filling station of the machine, which comprises a series of nozzles, which are movable in vertical direction between an operating position and a not operating position and which are apt to deposit a predetermined amount of liquid product inside the vials. The filling station performs for example three consecutive operating steps shown in FIGS. 2-4 which are carried out in three corresponding operating units: the step of blowing an inert gas by means of nozzles (4A) inside the vials to favour the air coming out and the filling of the vials with inert gas (FIG. 2); the step of filling the vials by means of nozzles (4B) with the liquid product up to a predetermined level (FIG. 3); and finally the step of blowing another inert gas by means of nozzles (4C) to remove the residual air inside the filled vials (FIG. 4).

The filled glass vials (1) are then moved towards a sealing station, in which the hermetic closing of the same vials is carried out.

During each movement and while the vials remain in the same sealing station, a laminar, with low particle content, vertical and constant top-down air flow abuts the “mouths” (8) of the same vials (1) so that possible impurities cannot deposit inside the vials (1); therefore the sterility of the air inside the operating chamber is an important process factor.

As it is known, a first pre-heating step and a second sealing step of the glass vials (1), shown in FIGS. 5 and 6 respectively, are carried out in the sealing station. During the pre-heating step, the vials (1) are drawn in rotation by suitable devices and the neck (2) of the vials (1) is pre-heated by means of localized heat produced by a series of heating means (5), for example Bunsen type burners or the like. In the next sealing step, gripping means (6) constituted by a series of pliers-counter-pliers supported by respective movable arms, grip the upper portion (9) of the neck (2) of the glass vials (FIG. 6).

In phase relation, the glass vials (1) are drawn in rotation with respect to their own axis and sealing means (11) submit the neck (2) of the vials (1) to another heating flow.

The combined action of the gripping means (6), of the rotation of the vials (6) and of the sealing means (11) causes a portion (9) of the neck of the vials (1) to be detached and the same vials (1) to be sealed.

The closing of the vials is carried out in fact by detaching a respective upper portion (9) of the neck (2) of the glass vials (FIG. 6) by means of the gripping means (6) and by subsequently aggregating the molten glass at the cutting area (7) to define a hermetic space (10) inside of the vials (FIG. 7). Such operations are favoured by the same vials rotation.

The operation of detaching the upper portion (9) of the neck (2) of the glass vials (1) produces glass waste, which is released in a hopper by the gripping means (6) and conveyed towards a collection container according to different known solutions.

According to a first known solution, said hopper is connected by means of a canalization to a glass waste collecting box, which is positioned on the frontal portion of the machine for filling vials. According to this solution, an operator empties the glass waste collecting box cyclically. The glass waste remaining inside the collecting box in the controlled-atmosphere chamber causes pollution due to the presence of fumes coming from the glass waste prior their cooling.

According to a second known solution, the hopper is connected to the outside of the controlled-atmosphere chamber by means of a piping which is vacuum-operated by means of a sucking device.

According to such a solution, the glass waste is therefore sucked and discharged in a container at the outside of the controlled-atmosphere chamber.

This makes it necessary to use a sucking device to suck the waste but at the same time sterile air is withdrawn from the inside of the chamber, thus requiring that the filtration/ventilation device of the controlled-atmosphere chamber is so dimensioned to compensate for the flow removed by the waste sucking device, with subsequently increased maintenance and working costs.

### SUMMARY OF THE INVENTION

Therefore, it is an object of the present invention to provide a device for conveying and removing glass waste, which is associable to a closing station of a machine for filling vials, which allows to overcome the previously lamented disadvantages of the known solutions, in particular allowing the sterility inside the controlled-atmosphere chamber to be left unchanged, and which is distinguished by low working/maintenance costs.

Another object of the present invention is to provide a simple, reliable and relatively cheap device with respect to the objects intended to be pursued.

The above cited objects are achieved by means of a device for conveying and removing glass waste, of a type which is associable to a sealing station of vials of a machine for filling the vials operating in a chamber in which there is a controlled atmosphere, with the sealing station comprising: means for sealing the vials positioned in the sealing station; means for gripping an upper part of the vials, the means for gripping being located above the sealing station, and acting in phase relation with the means for sealing in order to grip the upper part of the vials and to detach the upper part from the body of the vials, and thereafter to unload the upper part, or waste, into a hopper located laterally of the sealing station, the device comprising: conveyor organs of the waste connecting the hopper with a collection container of the waste positioned in a different environment from the controlled-atmosphere environment.

### BRIEF DESCRIPTION OF THE DRAWINGS

The features of the invention are highlighted in the following, with particular reference to the appended drawings, in which:

FIG. 1 shows a glass vial with open type neck;

FIG. 2 shows schematically the step of blowing an inert gas in the glass vial of FIG. 1;

FIG. 3 shows schematically the step of filling the glass vial of FIG. 1 with a liquid product;

FIG. 4 shows schematically the step of blowing an inert gas in the filled glass vial of FIG. 1;

FIG. 5 shows schematically the pre-heating step of the filled glass vial of FIG. 1;

FIG. 6 shows schematically the step of sealing the glass vial of FIG. 1;

FIG. 7 shows the glass vial of FIG. 1, filled and hermetically sealed;

FIG. 8 shows a frontal sectioned view of a machine for filling vials, wherein it is used a device for conveying and removing glass waste, which is object of the present invention;

FIG. 9 shows an enlarged view of the detail H of the machine for filling vials of FIG. 8.

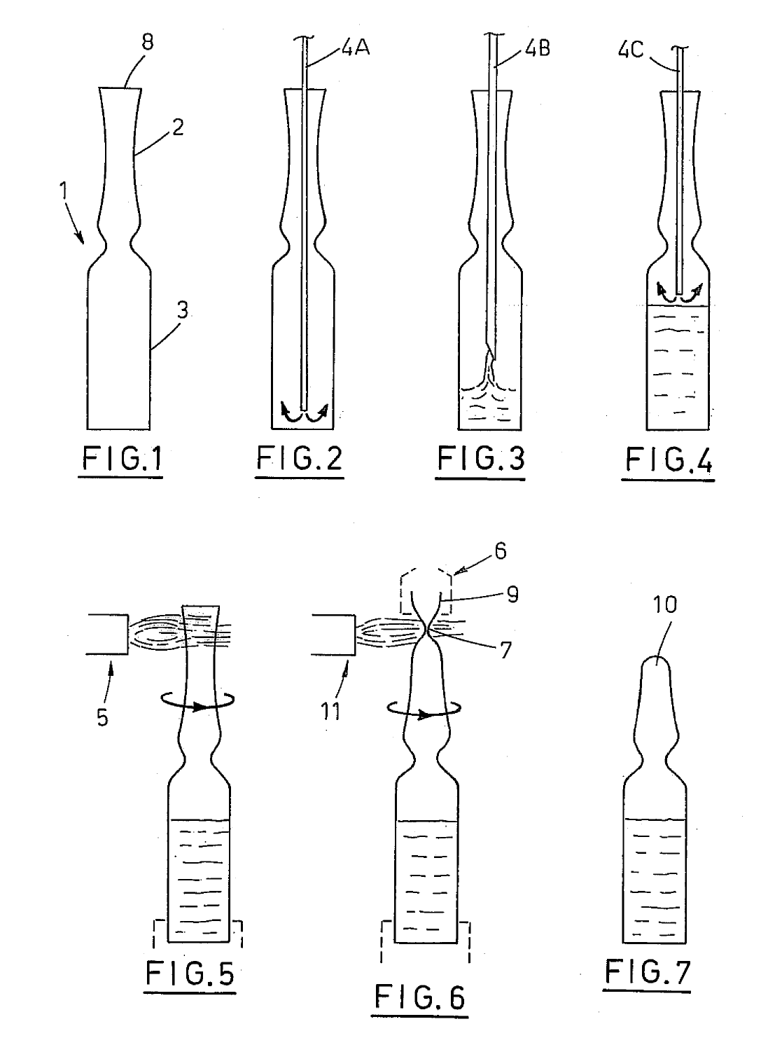

### DESCRIPTION OF THE PREFERRED EMBODIMENTS

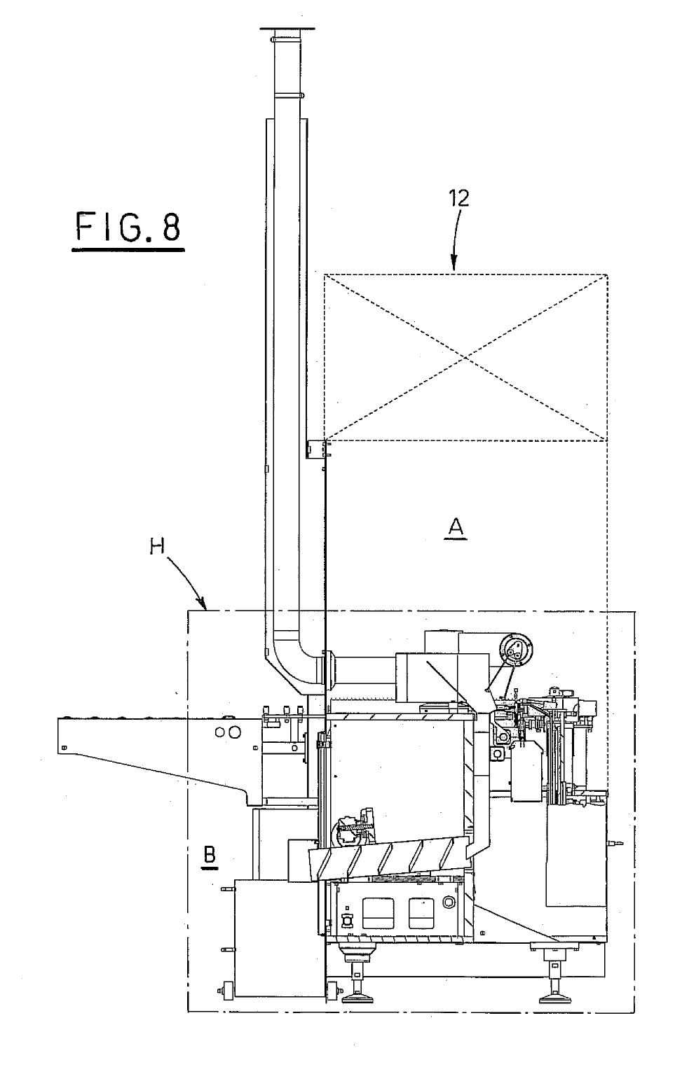

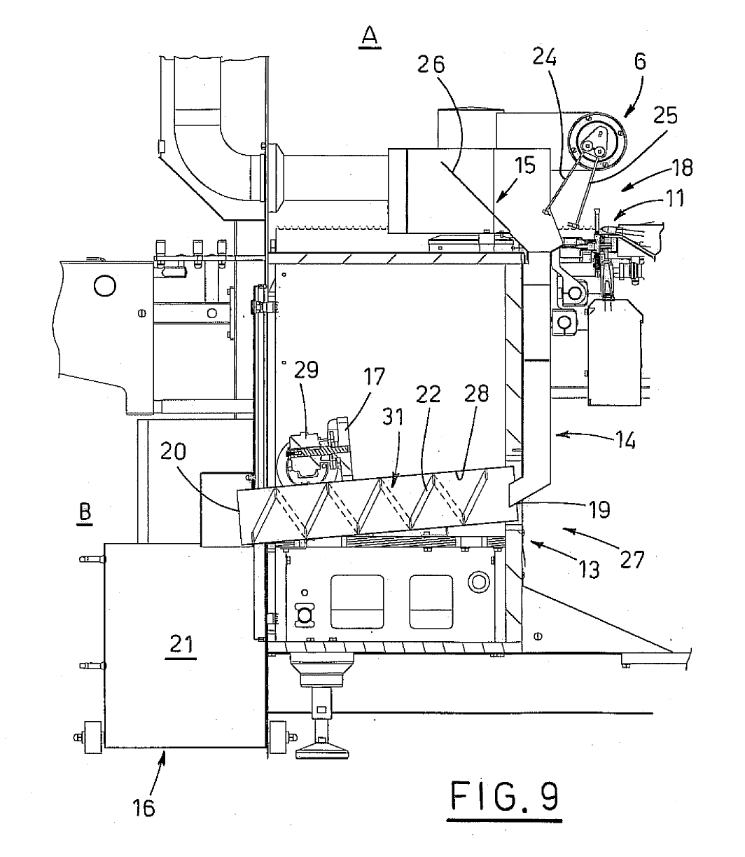

Particularly referring to FIGS. 8-9, the reference number (12) generally indicates a machine for filling vials operating in a controlled-atmosphere chamber (A), in which it is used the device according to the present invention, which is associated to a sealing station (18) of vials.

Such a machine (12) comprises a sealing station (18) comprising sealing means (11), apt to seal the glass vials (1) filled with the product, and gripping means (6), arranged above the same station and apt to detach the upper portion (9) or glass waste of the neck of the vials (1).

According to a preferred embodiment shown in FIGS. 8-9, the device for conveying and removing glass waste according to the present invention comprises: a collection hopper (15), arranged laterally of the sealing station (18) and intended to receive the glass waste produced by the gripping means (6) associated to the sealing station (18); conveyor organs (27) of the waste connecting the hopper (15) to a container (16) for collecting such waste, which is positioned in a different environment (B) from the controlled-atmosphere one.

The conveyor organs (27) comprise a first vertical portion (14), which is constituted by a piping, of which an end is connected to the hopper (15), and a second portion (13), which is constituted by a tubular portion, connecting the first portion (14) to the collection container (16), and which is inclined downwards between the first portion (14) and the collection container (16). The tubular body (13) is rotatably supported in known way (not shown) and drawn in rotation by means of known systems, for example by friction by means of a pulley (17) actuated by an electrical motor (29). The tubular body (13) comprises a first opening (19), connected to said first portion (14), a second opening (20), coming out in the inner space (21) of the collection container (16) of the glass waste and a helically extending rib (22) which is integral to it and arranged on the inner surface (28) of the same tubular body.

The functioning of the device for conveying and removing the glass waste is described in the following, with reference to the preferred embodiment.

In the sealing station (18), the gripping means (6), i.e. the series of pliers (24) and counter-pliers (25) detach the upper portion (9) of the neck (2) of the vials (1) thus producing glass waste, according to manners, already described in the beginning.

The series of pliers-counter-pliers (6) unloads the glass waste at the collection hopper (15) as a consequence of the opening of the jaws constituted by the pliers (24) coupled to the respective counter-pliers (25). The glass waste abut an abutment surface (26) of the collection hopper (15) and slide by means of gravity along the first portion (14) of the conveyor organs (27) up to the first opening (19) of the tubular portion (13). The tubular body (13) is drawn in continuous rotation so that, by means of the inner rib (22), it favors the glass waste moving from the first opening (19) to the inner space (21) of the waste collection container (16), where the removing and depositing of the same waste are carried out.

The inner rib (22) abuts the glass waste by means of its rotational motion, and drags them towards the collection container (16), even with limited inclinations of the tubular body (13).

The collection container (16) is cyclically emptied by an operator and since it is arranged at the outside (B) of the controlled-atmosphere chamber it is possible to avoid any alteration of sterility of the controlled-atmosphere chamber (A).

The advantage of the present invention is to provide a device for conveying and removing glass waste, of the type which is associable to a sealing station of a machine for filling glass vials, which allows to overcome the above lamented disadvantages of known type, in particular allowing the sterility of the controlled-atmosphere environment, in which the sealing of the glass vials is carried out with reduced costs, to be left unchanged.

Another advantage of the present invention is to define a device for conveying and removing glass waste, which is simple and reliable and relatively cheap with respect to the advantages achieved.

The device according to the present invention can be realized according to a not shown variant as well, wherein the tubular body is stationary and the inner rib is rotatable with respect to it and is drawn in rotation by means of systems of known type, thus achieving the same advantageous technical-functional features peculiar of the preferred embodiment.

It is intended that the preceding description is purely exemplary and not limiting, therefore possible structural variations are clearly intended to fall in the protective scope of the present technical solution, as above-described and defined by the following claims.

What is claimed:

1) A device for conveying and removing glass waste, of a type which is associable to a sealing station of vials of a machine for filling the vials operating in a chamber in which there is a controlled atmosphere, with the sealing station comprising: means for sealing the vials positioned in the sealing station; means for gripping an upper part of the vials, the means for gripping being located above the sealing station, and acting in phase relation with the means for sealing in order to grip the upper part of the vials and to detach the upper part from the body of the vials, and thereafter to unload the upper part, or waste, into a hopper located laterally of the sealing station, the device comprising: conveyor organs of the waste connecting the hopper with a collection container of the waste positioned in a different environment from the controlled-atmosphere environment.

2) The device of claim 1, wherein the conveyor organs comprise a first vertical portion of which an end is connected to the hopper, and wherein the conveyor organs further comprise a second portion which connects the first portion with the collection container, the second portion being inclined downwards between the first portion and the collection container.

3) The device of claim 2, wherein the second portion is constituted by a tubular body rotatably supported and drawn in rotation by corresponding means for activating, the tubular body internally comprising means for facilitating conveying of the waste towards the container.

4) The device of claim 3, wherein the means for facilitating conveying of the waste are constituted by at least a rib which is solidly constrained to the second portion, and which extends in a helical fashion.
